(19) United States
(12) Patent Application Publication
(10) Pub. No.: US 2026/0024874 A1
(43) Pub. Date: Jan. 22, 2026

(54) BATTERY CELL ASSEMBLY FOR A VEHICLE

(71) Applicant: GM Global Technology Operations LLC, Detroit, MI (US)

(72) Inventors: Meng Jiang, Rochester Hills, MI (US); Lei Wang, Rochester Hills, MI (US); Fengkun Wang, Rochester Hills, MI (US)

(73) Assignee: GM Global Technology Operations LLC, Detroit, MI (US)

(21) Appl. No.: 18/778,751

(22) Filed: Jul. 19, 2024

(51) Int. Cl. H01M 50/367; H01M 10/04; H01M 10/6554; H01M 50/491

(52) U.S. Cl. CPC H01M 50/367; H01M 10/0431; H01M 10/6554; H01M 50/491

(57) ABSTRACT

A battery cell assembly includes a housing, at least one electrode stack, a cooling plate, an insert, and a fluid flow path. The housing includes a first end and a second end and defines a cavity, the first end including terminals and the second end defining a vent. The at least one electrode stack is disposed within the cavity and includes interior portions defining a central space, the central space being aligned with the vent. The cooling plate is coupled to the second end of the housing. The insert is disposed within the central space of the at least one electrode stack. The fluid-flow path is selectively defined within the insert and directed toward the vent.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to a battery cell assembly, and specifically, to a battery cell assembly for a vehicle.

Battery cell assemblies are conventionally used in electric and hybrid electric vehicles to provide power to electric motors of such vehicles. During operation, such assemblies can experience a thermal runaway event if energy stored in the battery cell assemblies is released suddenly, thereby causing a temperature of the assemblies to rise rapidly.

A conventional battery cell assembly can mitigate the effects of a thermal runaway event by venting a cell can of the battery cell assembly to prevent excessive buildup of gas pressure within the assembly. In the absence of such venting, the buildup of pressure within the cell can could result in rupturing of the cell can and, thus, damage to the battery cell assembly and surrounding vehicle structure. Gas channels or passageways may be in fluid communication with a vent of the cell can in an effort to direct pressurized gas out of the cell can via the vent before the pressurized gas reaches a pressure that could cause damage to the cell can and surrounding vehicle structure.

In many battery cell assemblies, gas flows through passageways that are positioned between one or more internal side walls of the cell can and electrode stacks. The passageways continue between an internal bottom wall of the cell can and the one or more electrode stacks, eventually reaching the vent that is generally positioned at a center location of the bottom wall. Many battery cell assemblies include cell stack supports between the internal bottom wall of the cell can and the electrode stacks, which provide foundational support to the electrode stacks. Due to the position of the cell stack supports, the passageways are partially obstructed, reducing the volumetric flow of gas through the passageways.

The less volumetric flow of gas through the passageways, the slower and less efficiently gas can be vented out of the cell can compared to assemblies with passageways that offer greater volumetric flow due to larger passageways and less obstructions. Reducing volumetric flow may cause gas pressure to build up within the assembly quicker and reach a higher level of pressure compared to an assembly that offers faster and more efficient gas venting.

### SUMMARY

One aspect of the disclosure provides a battery cell assembly. The battery cell assembly includes a housing, at least one electrode stack, a cooling plate, an insert, and a fluid flow path. The housing includes a first end and a second end and defines a cavity, the first end including terminals and the second end defining a vent. The at least one electrode stack is disposed within the cavity and includes interior portions defining a central space, the central space being aligned with the vent. The cooling plate is coupled to the second end of the housing. The insert is disposed within the central space of the at least one electrode stack. The fluid-flow path is selectively defined within the insert and directed toward the vent.

Implementations of the disclosure may include one or more of the following optional features. In some examples, the at least one electrode stack may include a first electrode stack and a second electrode stack electrically coupled to the first electrode stack, the central space being defined between the first electrode stack and the second electrode stack.

In some implementations, the insert may include a frame configuration including side openings adjacent to the interior portions of the at least one electrode stack and end openings aligned with the vent. In some further implementations, the end opening may include a first end opening proximate to the first end of the housing and a second end opening proximate to the vent at the second end of the housing, the second end opening including a crossed structure having an X-shaped configuration.

In some aspects, the insert may include a plurality of channels extending between the first end and the second end of the housing.

In some configurations, the insert may include a porous material including at least one of a polymeric material, a metal material, and a metal foam material.

In some examples, the at least one electrode stack may include at least one of a jellyroll electrode stack and a layered electrode stack.

In some implementations, the insert may include sidewalls including a plurality of holes and a bottom wall defining an opening, the insert having a U-shaped configuration.

Another aspect of the disclosure provides a battery cell assembly. The battery cell assembly includes a housing, at least one electrode stack, an insert, and a fluid-flow path. The housing includes a first end and a second end and defining a cavity, the first end including terminals and the second end defining a vent. The at least one electrode stack is disposed within the cavity and includes interior portions defining a central space, the central space being aligned with the vent. The insert is disposed within the central space of the at least one electrode stack. The fluid-flow path is selectively defined within the insert and directed toward the vent.

Implementations of this aspect of the disclosure may include one or more of the following optional features. In some examples, the at least one electrode stack includes a first electrode stack including a first tab and a second electrode stack including a second tab welded to the first tab of the first electrode stack, the central space being defined between the first electrode stack and the second electrode stack.

In some implementations, the insert may have a frame configuration, the insert including side openings adjacent to the interior portions of the at least one electrode stack and end openings aligned with the vent. In some further implementations, the end openings may include a first end opening proximate to the first end of the housing and a second end opening proximate to the vent at the second end of the housing, the second end opening including a crossed structure having an X-shaped configuration.

In some aspects, the insert may include a plurality of channels extending between the first end and the second end of the housing.

In some configurations, the insert may include a porous material including at least one of a polymeric material, a metal material, and a metal foam material.

In some examples, the one or more electrode stacks may include at least one of a jellyroll electrode stack and a layered electrode stack.

In some implementations, the insert may include sidewalls including a plurality of holes and a bottom wall defining an opening, the insert having a U-shaped configuration.

Yet another aspect of the disclosure provides a vehicle. The vehicle includes a battery cell assembly. The battery cell assembly includes a housing, one or more electrode stacks, a cooling plate, an insert, a fluid-flow path. The housing includes a first end and a second end and defines a cavity, the first end including terminals and the second end defining a vent. The one or more electrode stacks are disposed within the cavity and are electrically coupled to the terminals of the housing, the one or more electrode stacks including interior portions defining a space aligned with the vent. The cooling plate is coupled to the second end of the housing. The insert is disposed within the space of the one or more electrode stacks, the insert including ventilation features with at least one of the ventilation features being adjacent to the vent. The fluid-flow path is selectively defined through the ventilation features of the insert and is directed toward the vent, the fluid-flow path defined by the one or more electrode stacks during operation.

Implementations of this aspect of the disclosure may include one or more of the following optional features. In some examples, the space defined by the interior portions of the one or more electrode stacks may extend along a longitudinal axis of the housing.

In some implementations, the insert may include at least one of a U-shaped configuration, an X-shaped configuration, and a frame configuration.

In some aspects, the ventilation features of the insert may include at least one of a porous material, a plurality of channels, and one or more openings

### BRIEF DESCRIPTION OF THE DRAWINGS

The drawings described herein are for illustrative purposes only of selected configurations and are not intended to limit the scope of the present disclosure.

FIG. 1 is a perspective view of a vehicle including a battery cell assembly;

FIG. 2 is a perspective view of a battery cell assembly according to the present disclosure;

FIG. 3 is a front cross-sectional view of the battery cell assembly of FIG. 2 taken along Line 3-3 in FIG. 2;

FIG. 4 is a bottom cross-sectional view of the battery cell assembly of FIG. 2 taken along Line 4-4 in FIG. 2;

FIG. 5 is a side cross-sectional view of a positive tab and a negative tab of the battery cell assembly of FIG. 2 taken along Line 5-5 in FIG. 2;

FIG. 6 is a front-view of an insert of a battery cell assembly according to the present disclosure;

FIG. 7 is a front-view of an alternative insert of a battery cell assembly according to the present disclosure;

FIG. 8 is a side-view of the insert of FIG. 6;

FIG. 9 is a bottom-view of the insert of FIG. 6;

FIG. 10 is a front-view of a frame insert of a battery cell assembly according to the present disclosure;

FIG. 11 is a side-view of the frame insert of FIG. 10;

FIG. 12A is a bottom-view of the frame insert of FIG. 10, the frame insert having a rectangularly-shaped configuration;

FIG. 12B is a bottom-view of the frame insert of FIG. 10, the frame insert having an X-shaped configuration;

FIG. 13 is a perspective view of a battery cell assembly according to the present disclosure;

FIG. 14 is a front cross-sectional view of the battery cell assembly of FIG. 13 taken along Line 14-14 in FIG. 13;

FIG. 15 is a side cross-sectional view of the battery cell assembly of FIG. 13 taken along Line 15-15 in FIG. 13;

FIG. 16 is a bottom cross-sectional view of the battery cell assembly of FIG. 13 taken along Line 16-16 in FIG. 13;

FIG. 17 is a perspective view of a battery cell assembly according to the present disclosure;

FIG. 18 is a front cross-sectional view of the battery cell assembly of FIG. 17 taken along line 18-18 in FIG. 17; and

FIG. 19 is a bottom cross-sectional view of the battery cell assembly of FIG. 16 taken along line 19-19 in FIG. 17.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICS (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

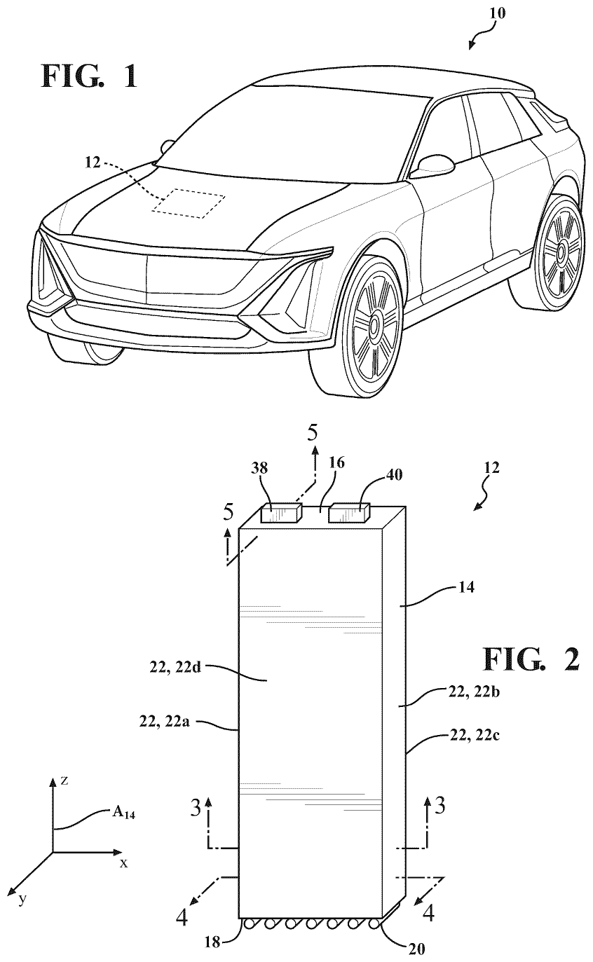

With reference to FIGS. 1-3, a vehicle 10 includes a battery cell assembly 12 that may be included as an internal component of a vehicle battery installed at the vehicle 10. The battery cell assembly 12 includes a housing 14 that houses various internal components associated with the battery cell assembly 12, such as one or more electrode stacks, an insert, a central space, a positive and a negative welding strip, a positive and a negative tab, and a fluid-flow path, all of which are described in greater detail below. The housing 14 may be shaped similarly to a cube or a rectangular prism. Additionally or alternatively, the housing 14 may have any practicable shape or configuration. The housing 14 includes a first end 16 and a second end 18 opposite the first end 16. When installed at the vehicle 10, the first end 16 is positioned generally above the second end 18. The second end 18 may be coupled to a cooling plate 20 of the battery cell assembly 12 that provides cooling capabilities to the battery cell assembly 12. Furthermore, the housing 14 includes a plurality of sidewalls 22 including a first wall 22a, a second wall 22b opposite the first wall 22a, a third wall 22c adjacent the first and second walls 22a, 22b, and a fourth wall 22d opposite the third wall 22c. The housing 14 also defines a cavity 24 between the first end 16, the second end 18, and the sidewalls 22. The battery cell assembly 12 further includes a vent 26 defined at the second end 18 to assist in releasing gasses that may buildup within the battery cell assembly 12 to prevent an excessive amount of gas pressure buildup within the housing 14. For example, an excessive volume of gasses may develop within the housing during a thermal runway event, and the vent 26 of the housing 14 is configured to rapidly clear and vent the gasses from the cavity 24, described in more detail below.

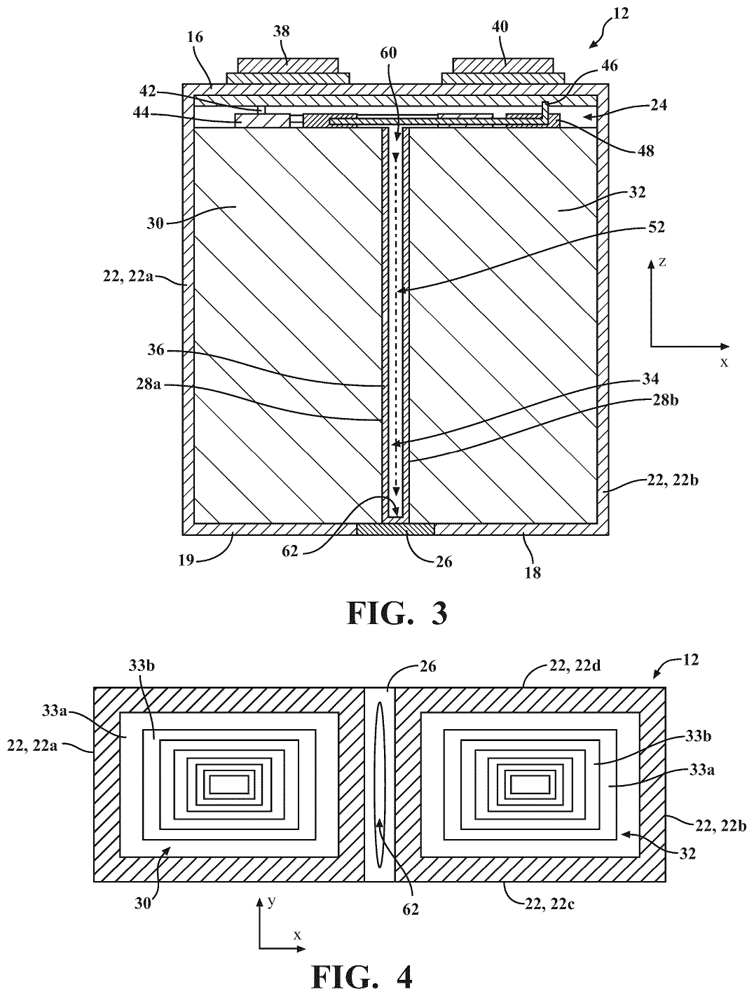

With reference to FIGS. 3 and 4, the battery cell assembly 12 includes a first electrode roll or electrode stack 30 and a second electrode roll or electrode stack 32 disposed within the cavity 24 of the housing. In some examples, the first electrode stack 30 and the second electrode stack 32 may include alternating anode assemblies 33a and cathode assemblies 33b configured to enable operation of the battery cell assembly 12. Each anode assembly 33a may include a foil-like material engaged with an anode, the foil-like material defining the anode assembly 33a. Likewise, each cathode assembly 33b may include a foil-like material engaged with a cathode, the foil-like material defining the cathode assembly 33b. Separating the alternating anode assemblies 33a and cathode assemblies 33b is a separator. In some examples, the electrode stacks 30, 32 may be configured with the alternating anode assemblies 33a and cathode assemblies 33b in a layered-like orientation along a z-axis. In other examples, electrode stacks 30, 32 may be configured with the alternating anode assemblies 33a and cathode assemblies 33b in a jellyroll-like orientation along the z-axis. In other examples, the electrode stacks 30, 32, may be oriented along the x-axis or the y-axis.

The first electrode stack 30 may engage with both the first wall 22a and the second end 18 of the housing 14, while the second electrode stack 32 may engage with both the second wall 22b and the second end 18 of the housing 14. It can be appreciated that both the first electrode stack 30 and the second electrode stack 32 may also engage with the third wall 22c and the fourth wall 22d. Both the first electrode stack 30 and the second electrode stack 32 may be of similar size and shape. A central space 34 is defined by interior portions 28a, 28b of the first electrode stack 30 and the second electrode stack 32 along a longitudinal axis A₁₄ of the housing 14. An insert 36 of the battery cell assembly 12 is disposed within the central space 34 and includes ventilation features. The ventilation features, as described in detail below, include, but are not limited to, a porous material, a plurality of channels, and/or one or more openings. The insert 36 is configured to separate the first electrode stack 30 and the second electrode stack 32, while advantageously facilitating flow of released gasses from the electrode stacks 30, 32. For example, the insert 36 may be configured in a variety of ways that accommodate the passage of gas through the central space 34, the configurations of which are described in greater detail below.

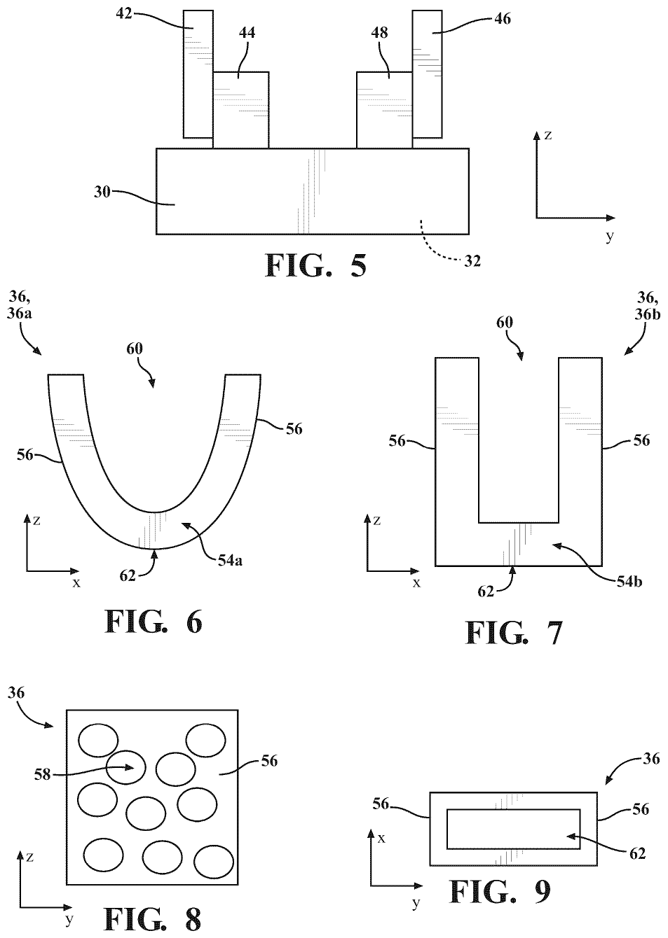

With reference to FIGS. 2-5, the first end 16 of the housing 14 includes a positive terminal 38 and a negative terminal 40 external of the cavity 24. The positive terminal 38 and the negative terminal 40 provide electrical connection points that allow the battery cell assembly 12 to electrically connect with electrical components and electrical circuitry included at the vehicle 10. Electrically connected to the positive terminal 38 is a positive welding strip 42 contained within the cavity 24. The positive welding strip 42 is fixed to a positive tab 44, which is also contained within the cavity 24. The positive welding strip 42 and the positive tab 44 are oriented between the first end 16 of the housing 14 and the first electrode stack 30. The positive tab 44 extends above the second electrode stack 32 to electrically couple the first electrode stack 30 with the second electrode stack 32. Likewise, a negative welding strip 46 is electrically connected to the negative terminal 40 and is contained within the cavity 24. The negative welding strip 46 is fixed to a negative tab 48, which is also contained within the cavity 24. The negative welding strip 46 and the negative tab 48 are oriented between the first end 16 of the housing 14 and the second electrode stack 32. The negative tab 48 also extends above the first electrode stack 30 to electrically couple the second electrode stack 32 with the first electrode stack 30.

In some examples, the positive welding strip 42 and the positive tab 44 may be positioned at a location between the first end 16 of the housing 14 and the second electrode stack 32, while the negative welding strip 46 and the negative tab 48 may be positioned at a location between the first end 16 of the housing 14 and the first electrode stack 30, without diverging from the context of this disclosure. Regardless of positioning, the positive welding strip 42 is electrically connected to the positive terminal 38, while the negative welding strip 46 is electrically connected to the negative terminal 40. Furthermore, the positive tab 44 and the negative tab 48 electrically couple the first electrode stack 30 and the second electrode stack 32 with one another, regardless of positioning.

With continued reference to FIGS. 3 and 4 the second end 18 of the housing 14 defines the vent 26, mentioned above, which is configured to vent gas from the cavity 24. For example, the vent 26 directs gas outward and external of the battery cell assembly 12. During operation of the battery cell assembly 12, the venting of gas advantageously manages the gas pressure within the housing 14 to prevent damage or rupturing of the housing 14. The vent 26 is aligned and fluidly coupled with the central space 34 to facilitate movement of gas and define a fluid-flow path 52. The fluid-flow path 52 may be further defined by the insert 36 disposed within the central space 34. Gas generated at both the first electrode stack 30 and the second electrode stack 32 travels outward from the electrode stacks 30, 32, into the cavity 24, and is routed to the fluid-flow path 52. The gas travels in a downward direction, from the first end 16 to the second end 18, along the fluid-flow path 52, until venting out of the housing 14 at the vent 26. The configuration of the fluid-flow path 52 being aligned with the vent 26 provides an unobstructed and linear route for gas to flow out of the housing 14, enhancing efficiency of gas venting out of the housing 14.

With reference now to FIGS. 6-9, as stated above, the insert 36 is configured to accommodate the passage of gas from the electrode stacks 30, 32 along the fluid-flow path 52 within the central space 34. In conjunction, the insert 36 is rigidly configured to separate the first electrode stack 30 from the second electrode stack 32 and prevent collapsing of the electrode stacks 30, 32 into the central space 34. To accommodate both functions of the insert 36, the insert 36 may be configured in a variety of ways, each of which may be included within the battery cell assembly 12.

With particular reference to FIGS. 6 and 7, a rounded insert 36a and a squared-off insert 36b are provided. In view of the substantial similarity in structure and function of the components associated with the insert 36, like reference numerals are used hereinafter and in the drawings to identify like components while like reference numerals containing letter and number extensions are used to identify those components that have been modified.

Inserts 36a, 36b have a respective bottom portion 54a, 54b that may have a rounded or squared-off configuration. For example, FIG. 6 illustrates an example of the rounded insert 36a having a U-shaped configuration, such that the bottom portion 54a of the rounded insert 36a may be rounded. In another example, FIG. 7 illustrates the squared-off insert 36b having a squared configuration, such that the bottom portion 54b of the squared-off insert 36b may be squared-off or rectangular. In either configuration, the bottom portions 54a, 54b are configured to engage with the vent 26 to facilitate the fluid-flow path 52 through the inserts 36a, 36b.

With particular reference to FIGS. 8 and 9, the insert 36, regardless of the configuration as described above, includes a pair of side portions 56 that extend along the y-axis between the first end 16 and the second end 18 of the housing 14. The pair of side portions 56 are engaged with the first electrode stack 30 and the second electrode stack 32. The pair of side portions 56 include a plurality of holes 58 that provide a means for gas to escape from the electrode stacks 30, 32 and through the insert 36, such that the fluid-flow path 52 allows gas to escape through the vent 26. The plurality of holes 58 may be defined as ventilation features of the insert 36 to assist in directing the expelled gas from the electrode stacks 30, 32 toward the vent 26. The plurality of holes 58 may be of any practicable size and shape that create porosity at the pair of side portions 56 and facilitate the movement of the gas along the fluid-flow path 52.

The insert 36 may include a porous material wherein the plurality of holes 58 are a feature of the porous material. The porous material may also be defined as the ventilation features of insert 36. The porous material may be at least one of a polymeric material, a metal material, and a metal foam material. The polymeric material may be polytetrafluoroethylene (PTFE), polyethylene (PE), polypropylene (PP), or something similar, while the metal or metal-foam material may be stainless steel, copper, aluminum, or something similar. Furthermore, the porous material may include regular channels wherein the plurality of holes 58 are linearly aligned with one another, or may include irregular channels wherein the plurality of holes 58 are irregularly aligned with one another.

The insert includes a first end opening 60 that is defined at a portion of the insert 36 that is closest to the first end 16 of the housing 14. The first end opening 60 accommodates movement of the fluid-flow path 52 into the insert 36 from an area of the cavity 24 that is situated closest to the first end 16 of the housing 14. Likewise, the bottom portion 54a of the rounded insert 36a, as well as the bottom portion 56b of the squared-off insert 36b, include a second end opening 62. The second end opening 62 is linearly aligned with the first end opening 60 and directly aligned with the vent 26 at the second end 18 of the housing 14. The second end opening 62 provides a means for the fluid-flow path 52 to flow out of the insert 36 and into the vent 26. The second end opening 62 may have a similar size and/or shape as compared with the plurality of holes 58 included at the pair of side portions 56 of the insert 36. Alternatively, the second end opening 62 may be distinct from the plurality of holes 58, such that the second end opening 62 is sized and shaped differently than the plurality of holes 58. The second end opening 62 may, thus, have any practicable size and shape that accommodates the fluid-flow path 52 from the insert 36 into the vent 26.

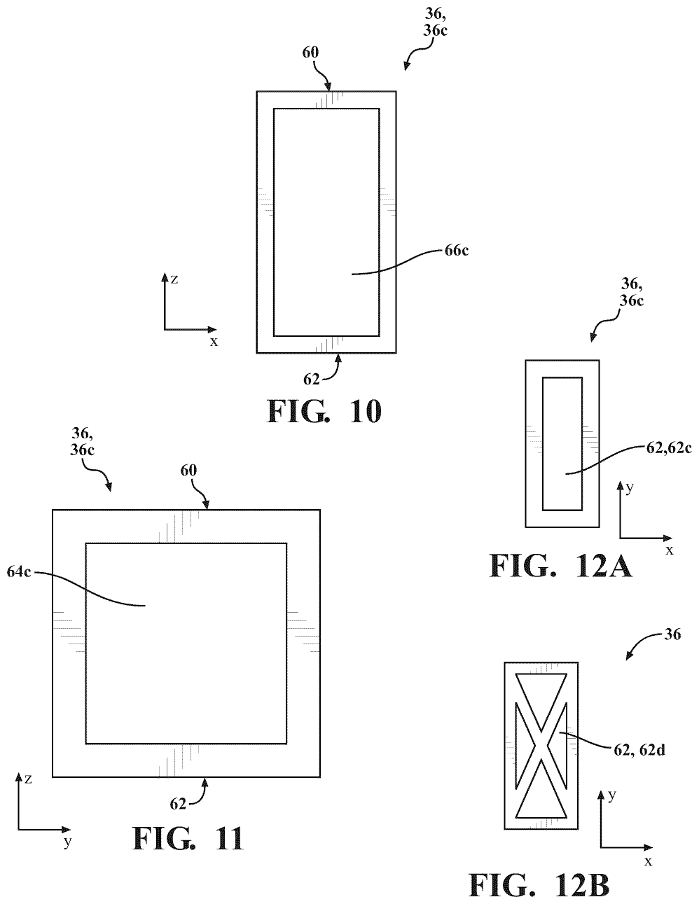

With particular reference to FIGS. 10-12B, a frame insert 36c is provided. In view of the substantial similarity in structure and function of the components associated with the insert 36, like reference numerals are used hereinafter and in the drawings to identify like components while like reference numerals containing letter and number extensions are used to identify those components that have been modified.

The frame insert 36c includes a pair of end openings 60, 62, a first pair of side openings 64c, and a second pair of side openings 66c. Similar to the rounded insert 36a and the squared-off insert 36b, the pair of end openings 60, 62 for the frame insert 36c include a first end opening 60 and a second end opening 62 that are linearly aligned with the vent 26 and are on opposite ends of the frame insert 36c along the z-axis. The first end opening 60 of the frame insert 36c accommodates movement of the fluid-flow path 52 into the frame insert 36c from an area of the cavity 24 that is situated closest to the first end 16 of the housing 14. The second end opening 62 provides a means for the fluid-flow path 52 to flow out of the insert 36 and into the vent 26.

The first pair of side openings 64c are engaged with the electrode stacks 30, 32 and are on opposite sides of the frame insert 36c along the x-axis. The second pair of side openings 66c are on opposite sides of the frame insert 36c along the y-axis. The fluid-flow path 52 is accommodated through each of the pair of end openings 60, 62, the pair of x-axis-aligned side openings 64c, and the pair of y-axis-aligned side openings 66, allowing the fluid-flow path 52 to be directed into the frame insert 36c, traveling in the direction from the first end 16 of the housing 14 to the second end 18 and through the vent 26, at which point, the fluid-flow path 52 exits the housing 14. Similar to the rounded insert 36a and the squared-off insert 36b, the frame insert 36c is rigidly configured as to separate the first electrode stack 30 from the second electrode stack 32 and prevent the electrode stacks 30, 32 from collapsing into the central space 34, while allowing sufficient space at the end openings 60, 62, 64c, 66c to accommodate the fluid-flow path 52.

With particular reference to FIGS. 12A and 12B, the second end opening 62 of the frame insert 36c may be configured as a rectangularly-shaped second end opening 62c or as an X-shaped second end opening 62d. For example, the second end opening 62d includes a crossed structure that has the X-shaped configuration. The configuration of the frame insert 36c may vary in a manner that corresponds to the shape of the second end opening 62. Whether the second end opening 62 of the frame insert 36c is the rectangularly-shaped second end opening 62c of the X-shaped second end opening 62d, accommodation of the fluid-flow path 52 to flow out of the insert 36 and into the vent 26 must be provided.

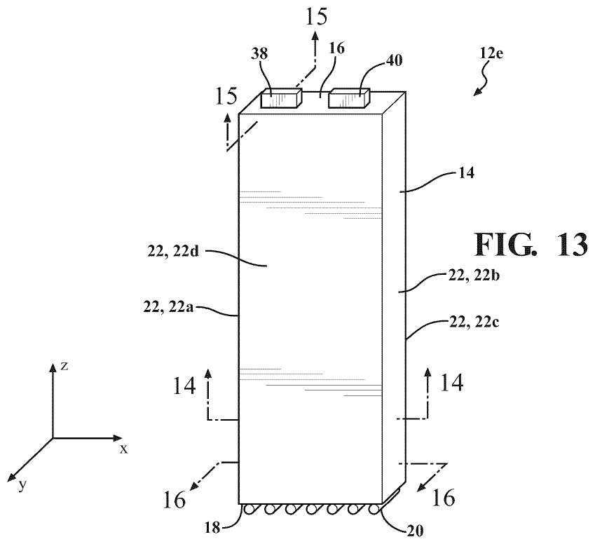

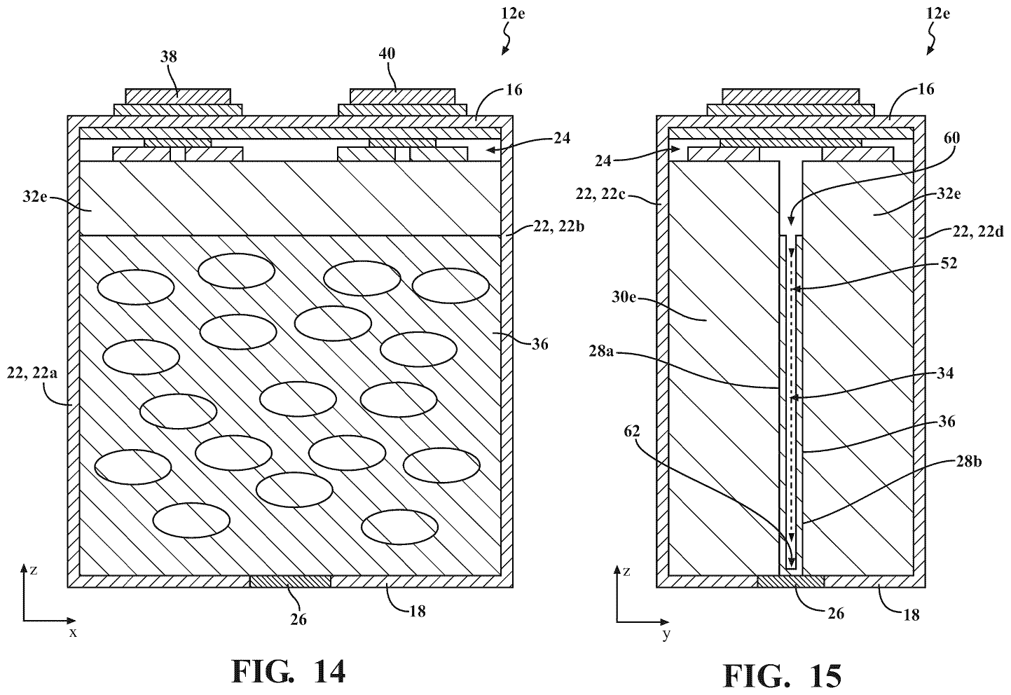

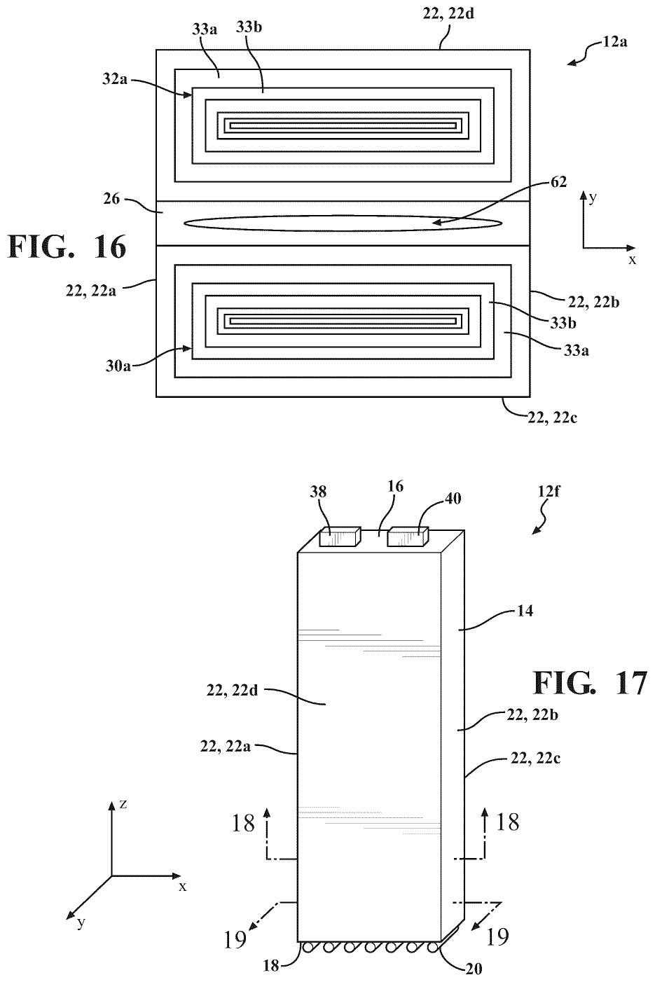

With reference to FIG. 13-16, a battery cell assembly 12e is provided. In view of the substantial similarity in structure and function of the components associated with the battery cell assembly 12, like reference numerals are used hereinafter and in the drawings to identify like components while like reference numerals containing letter and number extensions are used to identify those components that have been modified.

A rotated battery cell assembly 12e includes a first electrode stack 30e and a second electrode stack 32e that have been rotated 90 degrees within a housing 14 of the battery cell assembly 12e with respect to the z-axis (in comparison to the orientation of electrode stacks 30, 32 in the battery cell assembly 12). The first electrode stack 30e of the rotated battery cell assembly 12e is engaged with a third wall 22c of the housing 14, while the second electrode stack 32e of the rotated battery cell assembly 12e is engaged with a fourth wall 22d of the housing 14. The first and second electrode stacks 30e, 32e of the rotated battery cell assembly 12e may also engage with a first wall 22a and a second wall 22b of the housing 14. The separation of the first electrode stack 30e with the second electrode stack 32e occurs across the y-axis. Furthermore, the anode assemblies 33a and cathode assemblies 33b may be in a layered-like orientation along the z-axis or a jellyroll-like orientation along the z-axis.

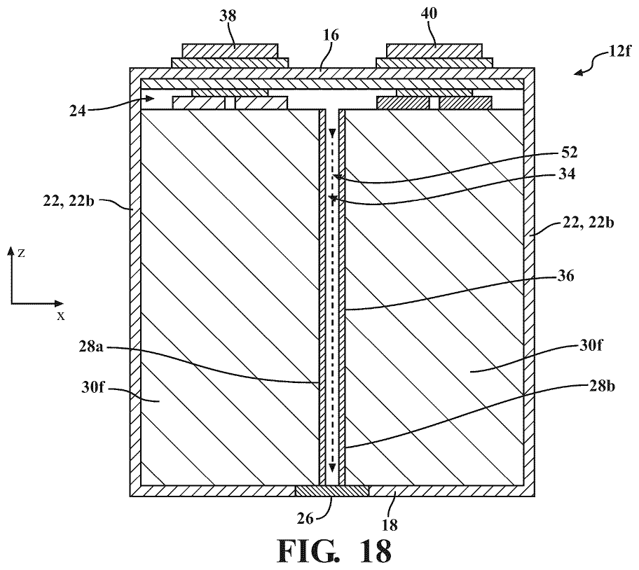

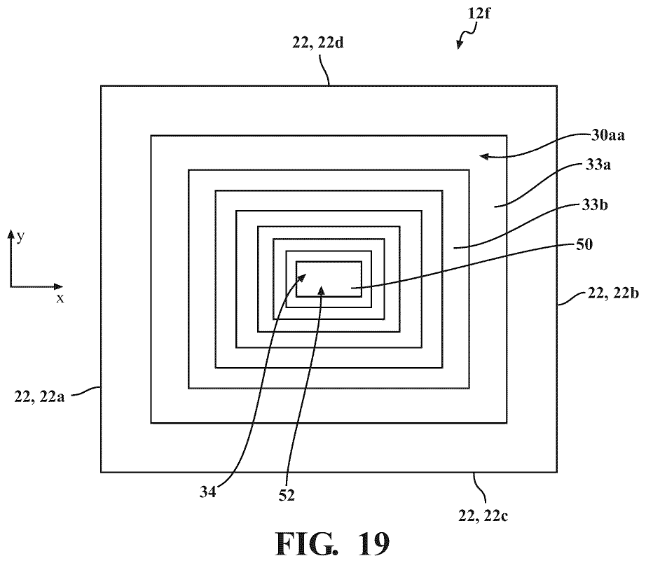

With reference to FIGS. 17-19, a battery cell assembly 12f is provided. In view of the substantial similarity in structure and function of the components associated with the battery cell assembly 12, like reference numerals are used hereinafter and in the drawings to identify like components while like reference numerals containing letter and number extensions are used to identify those components that have been modified.

A battery cell assembly 12f may include a single electrode stack 30f. The single electrode stack 30f engages with a first wall 22a, a second wall 22b, a third wall 22c, and a fourth wall 22d of a housing 14 of the battery cell assembly 12f. An insert 36 is included in the modified battery cell assembly 12f and is centered within the bounds of the first wall 22a, the second wall 22b, the third wall 22c, and the fourth wall 22d. The insert 36 may be a column-like structure while still advantageously defining the fluid-flow path 52 toward the vent 26 and rigidly preventing the single electrode stack 30f from self-collapsing. In doing so, the fluid-flow path may flow, unobstructed, from the single electrode stack 30f, through the insert 36, and out the vent 26. As mentioned above, the vent 26 is linearly aligned with the insert 36-36c. In the battery cell assembly 12f, the anode assemblies 33a and cathode assemblies 33b are in a jellyroll orientation along the z-axis.

During operation of the battery cell assembly 12, the insert 36 advantageously assists in efficiently expelling the fluid-flow path 52 of gas out of the housing 14. Thus, the insert 36 advantageously maintains a controlled and managed gas pressure within the housing 14. Aligning, in a linear configuration along the z-axis, the insert 36 with the vent 50, creates a direct and unencumbered fluid-flow path 52 for gas to flow from the electrode stacks 30, 32, and out of the housing 14 through the vent 26.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A battery cell assembly comprising:
a housing including a first end and a second end and defining a cavity, the first end including terminals and the second end defining a vent;
at least one electrode stack disposed within the cavity and including interior portions defining a central space, the central space being aligned with the vent;
a cooling plate coupled to the second end of the housing;
an insert disposed within the central space of the at least one electrode stack; and
a fluid-flow path selectively defined within the insert and directed toward the vent.

2. The battery cell assembly of claim 1, wherein the at least one electrode stack includes a first electrode stack and a second electrode stack electrically coupled to the first electrode stack, the central space being defined between the first electrode stack and the second electrode stack.

3. The battery cell assembly of claim 1, wherein the insert includes a frame configuration including side openings adjacent to the interior portions of the at least one electrode stack and end openings aligned with the vent.

4. The battery cell assembly of claim 3, wherein the end openings include a first end opening proximate to the first end of the housing and a second end opening proximate to the vent at the second end of the housing, the second end opening including a crossed structure having an X-shaped configuration.

5. The battery cell assembly of claim 1, wherein the insert includes a plurality of channels extending between the first end and the second end of the housing.

6. The battery cell assembly of claim 1, wherein the insert includes a porous material including at least one of a polymeric material, a metal material, and a metal foam material.

7. The battery cell assembly of claim 1, wherein the at least one electrode stack includes at least one of a jellyroll electrode stack and a layered electrode stack.

8. The battery cell assembly of claim 1, wherein the insert includes sidewalls including a plurality of holes and a bottom wall defining an opening, the insert having a U-shaped configuration.

9. A battery cell assembly comprising:
a housing including a first end and a second end and defining a cavity, the first end including terminals and the second end defining a vent;
at least one electrode stack disposed within the cavity and including interior portions defining a central space, the central space being aligned with the vent;
an insert disposed within the central space of the at least one electrode stack; and
a fluid-flow path selectively defined within the insert and directed toward the vent.

10. The battery cell assembly of claim 9, wherein the at least one electrode stack includes a first electrode stack including a first tab and a second electrode stack including a second tab welded to the first tab of the first electrode stack, the central space being defined between the first electrode stack and the second electrode stack.

11. The battery cell assembly of claim 9, wherein the insert has a frame configuration, the insert including side openings adjacent to the interior portions of the at least one electrode stack and end openings aligned with the vent.

12. The battery cell assembly of claim 11, wherein the end openings include a first end opening proximate to the first end of the housing and a second end opening proximate to the vent at the second end of the housing, the second end opening including a crossed structure having an X-shaped configuration.

13. The battery cell assembly of claim 9, wherein the insert includes a plurality of channels extending between the first end and the second end of the housing.

14. The battery cell assembly of claim 9, wherein the insert includes a porous material including at least one of a polymeric material, a metal material, and a metal foam material.

15. The battery cell assembly of claim 9, wherein the at least one or more electrode stacks includes at least one of a jellyroll electrode stack and a layered electrode stack.

16. The battery cell assembly of claim 9, wherein the insert includes sidewalls including a plurality of holes and a bottom wall defining an opening, the insert having a U-shaped configuration.

17. A vehicle comprising:
a battery cell assembly including:
a housing including a first end and a second end and defining a cavity, the first end including terminals and the second end defining a vent;
one or more electrode stacks disposed within the cavity and electrically coupled to the terminals of the housing, the one or more electrode stacks including interior portions defining a space aligned with the vent;
a cooling plate coupled to the second end of the housing;
an insert disposed within the space of the one or more electrode stacks, the insert including ventilation features, at least one of the ventilation features being adjacent to the vent; and
a fluid-flow path selectively defined through the ventilation features of the insert and directed toward the vent, the fluid-flow path defined by the one or more electrode stacks during operation.

18. The vehicle of claim 17, wherein the space defined by the interior portions of the one or more electrode stacks extends along a longitudinal axis of the housing.

19. The vehicle of claim 17, wherein the insert includes at least one of a U-shaped configuration, an X-shaped configuration, and a frame configuration.

20. The vehicle of claim 17, wherein the ventilation features of the insert include at least one of a porous material, a plurality of channels, and one or more openings.
